(19) United States
(12) Patent Application Publication
(10) Pub. No.: US 2014/0071372 A1
(43) Pub. Date: Mar. 13, 2014

(54) Backlight Module With Heat Dissipating Arrangement and Liquid Crystal Display Device

(71) Applicant: Dehua Li, Shenzhen City (CN)

(72) Inventor: Dehua Li, Shenzhen City (CN)

(73) Assignee: SHENZHEN CHINA STAR OPTOELECTRONICS TECHNOLOGY CO., LTD., Shenzhen, Guangdong (CN)

(21) Appl. No.: 13/643,103

(22) PCT Filed: Sep. 26, 2012
(86) PCT No.: PCT/CN2012/082023

§ 371 Date: Oct. 24, 2012

(30) Foreign Application Priority Data
Sep. 12, 2012 (CN) CN 201210336026.4

(51) Int. Cl. F21V 29/00; G02F 1/1335; G09F 13/04

(52) U.S. Cl. CPC F21V 29/002; G09F 13/04; G02F 1/1336
USPC 349/58; 362/97.1

(57) ABSTRACT

The present invention provides a backlight module having heat-dissipating device, and a liquid crystal display module incorporated with such a backlight module. The backlight module includes including a backboard, a membrane, and an aluminum extrusion, the backboard defined with recess with the membrane covered thereon, and the aluminum extrusion is arranged on side of the backboard. The present invention provides a backlight module with a heat dissipating device and a liquid crystal display module incorporated with such a backlight module. The heat-dissipating device includes a recess in which hot airflow can be readily directed upward and distributed to the whole backboard, and eventually dissipated into the ambient air. Accordingly, the heat dissipating capacity of the backlight module is increased, and the service life and performance of the LED is therefore prolonged and increased.

### CROSS REFERENCE

This application is claiming a priority arisen from a patent application, entitled with “Backlight Module and Liquid Crystal Display Device”, submitted to China Patent Office on Sep. 12, 2012, designated with an Application Number 201210336026.4. The whole and complete disclosure of such patent application is hereby incorporated by reference.

The present invention relates to a technical field of liquid crystal display, and more particularly, to a backlight module with a heat dissipating device and a liquid crystal display device incorporated with such a backlight module.

### DESCRIPTION OF PRIOR ART

A typical liquid crystal display module is generally configured with a liquid crystal display panel, a frame and an optical component module. Currently, the light source incorporated within the backlight module can be categorized into CCFL (cold cathode fluorescent lamp), and LED (light emitting diode). The LED is comparably new device in the liquid crystal display device, and which features brighter and lower energy consumption. Accordingly, the LED has become more and more popular, and even become the main trend in the backlight module because of its compact, low energy consumption, super-thin, and readily implemented with narrow-boarder arrangement.

As to the backlight module with LED module arranged in side manner, heat generated from operation of the LED builds up quickly since the LED can still generate a great deal of heat. Once the temperature rises, the quantum performance of the LED will drop drastically. Consequently, the brightness of the LED will also drop, and the life span of the LED is also reduced. Accordingly, a heat dissipating device has to be incorporated to effectively dissipate the heat generated from the LED so as to keep the LED work functionally as it should.

Currently, the LED strip is attached to an aluminum extrusion to dissipate heat generated thereof. However, this prior art arrangement cannot effectively dissipate the heat, and the service life of the LED is jeopardized.

### SUMMARY OF THE INVENTION

It is an objective of the present invention to provide a backlight module with a heat-dissipating device arranged therein so as to effectively dissipate the heat generated by the LED module so as to increase the service life and performance of the LED module. The present invention further provides a liquid crystal display device incorporated with such a backlight module.

The present invention provides a backlight module with a heat-dissipating device, and which includes a backboard, a membrane, and an aluminum extrusion. The backboard is defined with recesses with the membrane covered thereon, and the aluminum extrusion is arranged on side of the backboard.

Wherein a surface of the recess is provided with serration or fin-like arrangement.

Wherein the recess is defined with openings.

Wherein the membrane is made from aluminum foil or Polyethylene terephthalate (PET), and other film made from polyester, or even galvanized steel plate.

Wherein there is at least two recesses defined.

Wherein when a longitudinal side of the backboard is served as an incident surface, the recesses is defined in adjacent to the longitudinal side of the backboard and perpendicular to the longitudinal side; wherein the aluminum extrusion is arranged on the longitudinal side of the backboard.

Wherein when the transversal side of the backboard is served as an incident surface, the recess is arranged in adjacent to the transversal side of the backboard, and is in oblique to the transversal side of the backboard; wherein the aluminum extrusion is arranged on the transversal side of the backboard.

The present invention further provides a liquid crystal display module which includes a liquid crystal display panel, a frame, a light source and a backlight module, wherein the light source is arranged on a heat dissipating device on the backlight module, and the liquid crystal display panel is fixedly assembled with the backlight module with the frame.

The present invention provides a backlight module with a heat dissipating device and a liquid crystal display module incorporated with such a backlight module. The heat-dissipating device includes a recess in which hot airflow can be readily directed upward and distributed to the whole backboard, and eventually dissipated into the ambient air. Accordingly, the heat dissipating capacity of the backlight module is increased, and the service life and performance of the LED is therefore prolonged and increased.

### BRIEF DESCRIPTION OF DRAWINGS

In order to give a better and thorough understanding to the whole and other intended purposes, features and advantages of the technical solution of the present invention, detailed description will be given with respect to preferred embodiments provided and illustrated herebelow in accompanied drawings. Apparently, with the spirit of the embodiments disclosed, person in the skilled in the art can readily come out with other modifications as well as improvements without undue experiment. In addition, other drawings can be readily achieved based on the disclosed drawings.

FIG. 1 is an illustrational and structural view of a backlight module made in accordance with a first preferred embodiment of the present invention;

FIG. 2 is an illustration for assembling of the backlight module shown in FIG. 1;

FIG. 3 is another illustration for assembling of the backlight module shown in FIG. 1;

FIG. 4 is a working principle of the backlight module shown in FIG. 1;

FIG. 5 is an illustrational and structural view of a backlight module made in accordance with a second preferred embodiment of the present invention;

FIG. 6 is an illustration for assembling of the backlight module shown in FIG. 5; and

FIG. 7 is a working principle of the backlight module shown in FIG. 5.

### SUBSTANTIAL IMPLEMENTATIONS

The heat dissipating capacity of a liquid crystal display module is largely depending on the heat-dissipating path of an LED, a convention of the backlight module, and a coefficient of radiation of the heat-dissipating device. The lower the thermal resistance, the higher the coefficient of heat convention and the larger the surface area, the higher the heat dissipating capacity. As a result, the heat generated by the LED light source can be effectively dissipated. In light of this, the present invention provides a backlight module incorporated with a heat-dissipating device such that the service life of the LED can be prolonged as the heat generated therefrom can be effectively dissipated.

The present invention provides a backlight module with a heat-dissipating device, and which includes a backboard, a membrane, and an aluminum extrusion. The backboard is defined with recesses with the membrane covered thereon, and the aluminum extrusion is arranged on side of the backboard.

Wherein a surface of the recess is provided with serration or fin-like arrangement.

Wherein the recess is defined with openings.

Wherein the membrane can be made from aluminum foil, Polyethylene terephthalate (PET), and other film made from polyester, or even galvanized steel plate.

Wherein there is at least two recesses defined.

Wherein when a longitudinal side of the backboard is served as an incident surface, the recesses is defined in adjacent to the longitudinal side of the backboard and perpendicular to the longitudinal side; wherein the aluminum extrusion is arranged on the longitudinal side of the backboard.

Wherein when the transversal side of the backboard is served as an incident surface, the recess is arranged in adjacent to the transversal side of the backboard, and is in oblique to the transversal side of the backboard; wherein the aluminum extrusion is arranged on the transversal side of the backboard.

Detailed description of preferred embodiment will be given in view of the preferred embodiments along with the accompanied drawings.

FIG. 1 is an illustrational and structural view of a backlight module made in accordance with a first preferred embodiment of the present invention.

FIG. 1 discloses a backboard 1 in which a longitudinal side is served as a light incident surface, and a heat-dissipating device is arranged therein. As shown in FIG. 1, the backboard 1 is defined with a plurality of recesses 10 serving as a path for heat convention. A surface of the recess 10 is provided with serrations or fins to as to increase a surface area thereof. As such, the heat dissipating capacity is also increased. The recess 10 is also defined with opening 11 (as marked in circle) for ventilation.

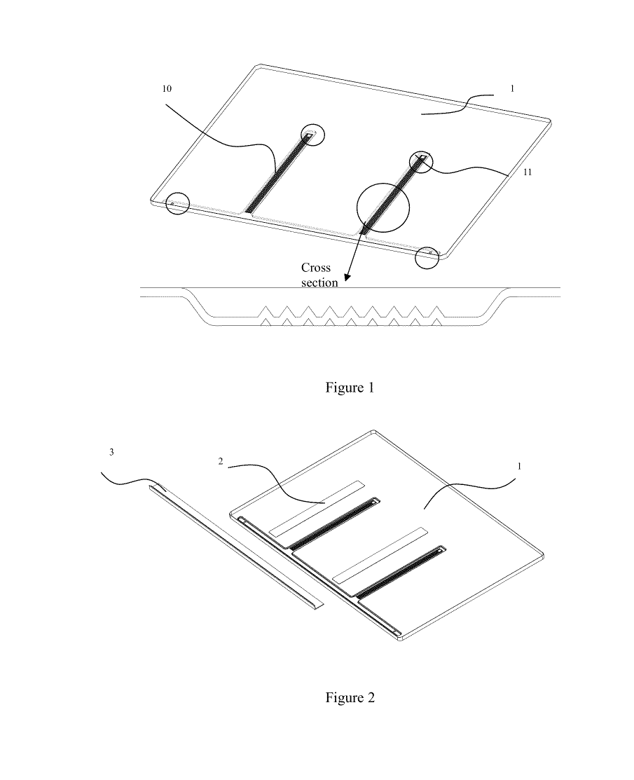

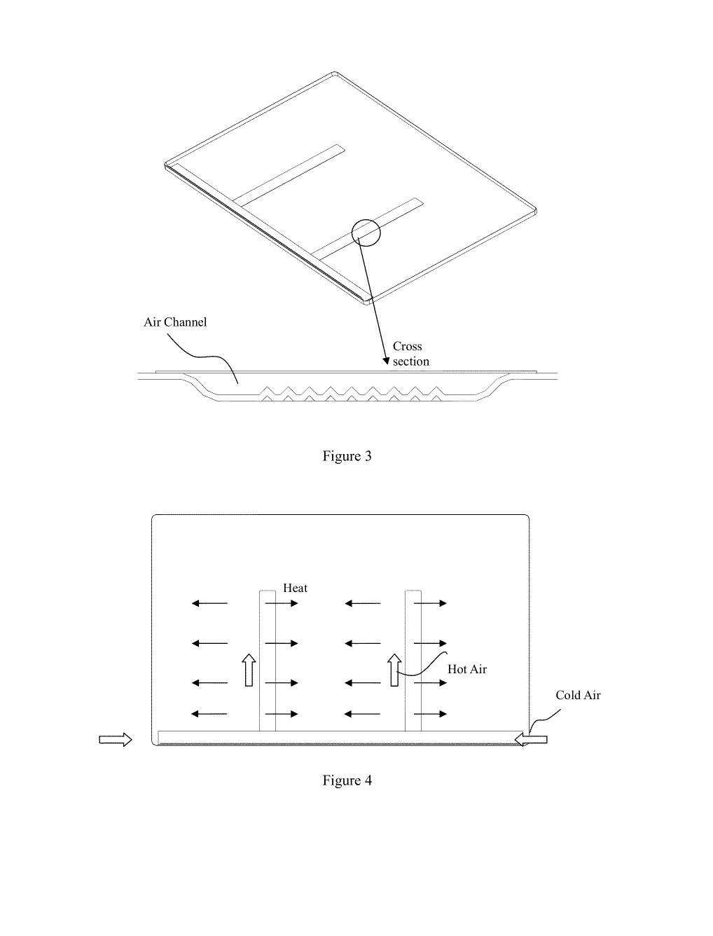

FIG. 2 is an illustration for assembling of the backlight module shown in FIG. 1, and FIG. 3 is another illustration for assembling of the backlight module shown in FIG. 1.

As shown in FIGS. 2 and 3, an aluminum extrusion 3 and a membrane 3 are installed onto the backboard 1. The membrane 2 can be made from aluminum foil, Polyethylene terephthalate (PET), and other film made from polyester, or even galvanized steel plate. With the provision of the membrane 2 and the aluminum extrusion 3, an air channel is created for convention.

FIG. 4 is a working principle of the backlight module shown in FIG. 1.

Within the channel, the hot air presses upward so as to create a pattern as shown in FIG. 4. The hot air can evenly and efficiently distribute the heat to backboard 1 so as to effectively dissipate the heat generated from the LED. As a result, enhanced heat dissipation is therefore reached. In addition, with this genuine design, a violent airflow or convention can be created within the channel, and this will again enhance the heat dissipation through convention. Accordingly, once the heat generated from the LED can be quickly and efficiently dissipated, the LED is also cooled down.

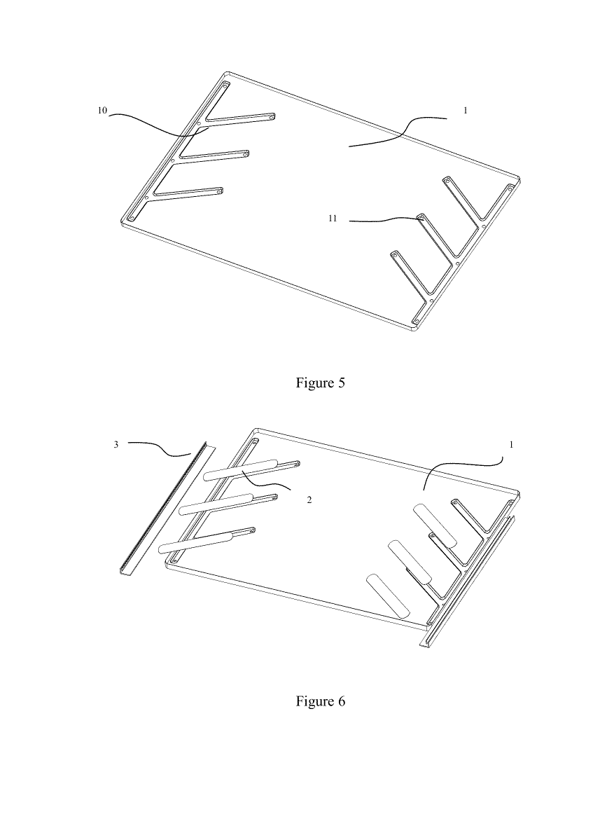

FIG. 5 is an illustrational and structural view of a backlight module made in accordance with a second preferred embodiment of the present invention.

FIG. 5 is an illustrational and structural view of a backlight module made in accordance with a second preferred embodiment of the present invention. As shown in FIG. 5, the backboard 1 is defined with recess 10, as disclosed, for ventilation of heat wave. A surface of the recess 10 is defined with serration or fins so as to increase the surface area so as to increase the capacity of heat dissipation. The recess 10 is further defined with openings (as encircled) to ventilation of the air. The different between FIGS. 1 and 5 is that the recess 10 is directed obliquely upward such the hot air can be readily directed outward through the recess 10. As the hot airflow vents through, the heat carried by the hot wave can be properly distributed to the backboard 1. A forced airflow can be created within the channel so as to bring a better heat dissipating result.

FIG. 6 is an illustration for assembling of the backlight module shown in FIG. 5.

As shown in FIG. 6, an aluminum extrusion 3 and a membrane 3 are installed onto the backboard 1. The membrane 2 can be made from aluminum foil, Polyethylene terephthalate (PET), and other film made from polyester, or even galvanized steel plate. With the provision of the membrane 2 and the aluminum extrusion 3, an air channel is created for convention.

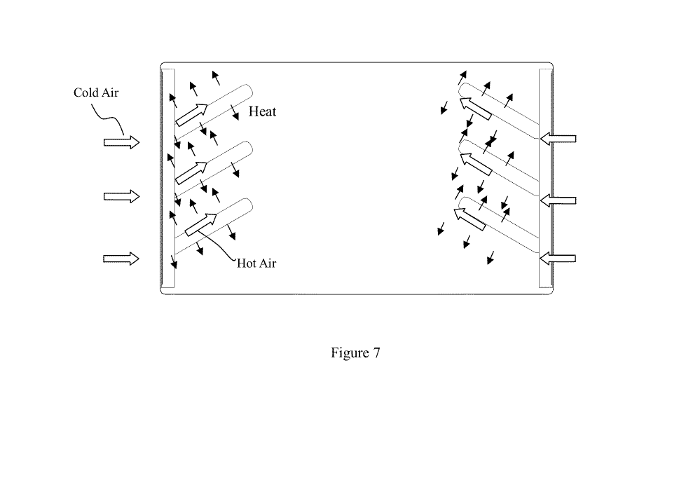

FIG. 7 is a working principle of the backlight module shown in FIG. 5.

Within the channel, the hot air presses upward so as to create a pattern as shown in FIG. 7. The hot air can evenly and efficiently distribute the heat to backboard 1 so as to effectively dissipate the heat generated from the LED. As a result, enhanced heat dissipation is therefore reached. In addition, with this genuine design, a violent airflow or convention can be created within the channel, and this will again enhance the heat dissipation through convention. Accordingly, once the heat generated from the LED can be quickly and efficiently dissipated, the LED is also cooled down.

The present invention further provides a liquid crystal display module which includes a liquid crystal display panel, a frame, a light source and a backlight module, wherein the light source is arranged on a heat dissipating device on the backlight module, and the liquid crystal display panel is fixedly assembled with the backlight module with the frame.

The present invention provides a backlight module with a heat dissipating device and a liquid crystal display module incorporated with such a backlight module. The heat-dissipating device includes a recess in which hot airflow can be readily directed upward and distributed to the whole backboard, and eventually dissipated into the ambient air. Accordingly, the heat dissipating capacity of the backlight module is increased, and the service life and performance of the LED is therefore prolonged and increased.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A backlight module with heat dissipating device, including a backboard, a membrane, and an aluminum extrusion, the backboard defined with recess with the membrane covered thereon, and the aluminum extrusion is arranged on side of the backboard.

2. The backlight module with heat dissipating device as recited in claim 1, wherein a surface of the recess is provided with serration or fin-like arrangement.

3. The backlight module with heat dissipating device as recited in claim 2, wherein the recess is defined with openings.

4. The backlight module with heat dissipating device as recited in claim 1, wherein the membrane can be made from aluminum foil, Polyethylene terephthalate (PET), and other film made from polyester, or even galvanized steel plate.

5. The backlight module with heat dissipating device as recited in claim 1, wherein there is two recesses.

6. The backlight module with heat dissipating device as recited in claim 5, wherein when a longitudinal side of the backboard is served as an incident surface, the recesses is defined in adjacent to the longitudinal side of the backboard and perpendicular to the longitudinal side; wherein the aluminum extrusion is arranged on the longitudinal side of the backboard.

7. The backlight module with heat dissipating device as recited in claim 5, wherein when the transversal side of the backboard is served as an incident surface, the recess is arranged in adjacent to the transversal side of the backboard, and is in oblique to the transversal side of the backboard; wherein the aluminum extrusion is arranged on the transversal side of the backboard.

8. A backlight module with heat dissipating device, including a backboard, a membrane, and an aluminum extrusion, the backboard defined with recess with the membrane covered thereon, and the aluminum extrusion is arranged on side of the backboard;
wherein a surface of the recess is provided with serration or fin-like arrangement.

9. The backlight module with heat dissipating device as recited in claim 8, wherein the recess is defined with openings.

10. The backlight module with heat dissipating device as recited in claim 9, wherein the membrane can be made from aluminum foil, Polyethylene terephthalate (PET), and other film made from polyester, or even galvanized steel plate.

11. The backlight module with heat dissipating device as recited in claim 10, wherein there is two recesses.

12. The backlight module with heat dissipating device as recited in claim 11, wherein when a longitudinal side of the backboard is served as an incident surface, the recesses is defined in adjacent to the longitudinal side of the backboard and perpendicular to the longitudinal side; wherein the aluminum extrusion is arranged on the longitudinal side of the backboard.

13. The backlight module with heat dissipating device as recited in claim 11, wherein when the transversal side of the backboard is served as an incident surface, the recess is arranged in adjacent to the transversal side of the backboard, and is in oblique to the transversal side of the backboard; wherein the aluminum extrusion is arranged on the transversal side of the backboard.

14. A liquid crystal display module configured with a liquid crystal display panel, a frame, a light source, and a backlight module having heat-dissipating device,
wherein the light source is arranged onto the backlight module, and the liquid crystal display panel is attached to the backlight module by the frame;
wherein the backlight module includes including a backboard, a membrane, and an aluminum extrusion, the backboard defined with recess with the membrane covered thereon, and the aluminum extrusion is arranged on side of the backboard.

15. The liquid crystal display module as recited in claim 14, wherein a surface of the recess is provided with serration or fin-like arrangement.

16. The liquid crystal display module as recited in claim 15, wherein the recess is defined with openings.

17. The liquid crystal display module as recited in claim 16, wherein the membrane can be made from aluminum foil, Polyethylene terephthalate (PET), and other film made from polyester, or even galvanized steel plate.

18. The liquid crystal display module as recited in claim 17, wherein there is two recesses.

19. The liquid crystal display module as recited in claim 18, wherein when a longitudinal side of the backboard is served as an incident surface, the recesses is defined in adjacent to the longitudinal side of the backboard and perpendicular to the longitudinal side; wherein the aluminum extrusion is arranged on the longitudinal side of the backboard.

20. The liquid crystal display module as recited in claim 18, wherein when the transversal side of the backboard is served as an incident surface, the recess is arranged in adjacent to the transversal side of the backboard, and is in oblique to the transversal side of the backboard; wherein the aluminum extrusion is arranged on the transversal side of the backboard.
